(19) United States
(12) Patent Application Publication
(10) Pub. No.: US 2005/0231725 A1
(43) Pub. Date: Oct. 20, 2005

(54) Method and device for visual range measurements with image sensor systems

(76) Inventor: Matthias Franz, Tuebingen (DE)

Correspondence Address: KENYON & KENYON, ONE BROADWAY, NEW YORK, NY, 10004, US

(21) Appl. No.: 10/513,197

(22) PCT Filed: Mar. 27, 2003
(86) PCT No.: PCT/DE03/01017

§ 371 Date: Jun. 7, 2005

(30) Foreign Application Priority Data
May 3, 2002 (DE) 102 19 788.1

(51) Int. Cl. G01N 21/00

(52) U.S. Cl. 356/437

(57) ABSTRACT

A method and a device for measuring the visual range using image sensor systems made up of at least two image sensors which record generally the same scene. Objects are detected from the image sensor signals whose distance with respect to the image sensor system is calculated, the object contrast is determined and the visual range is ascertained.

### FIELD OF THE INVENTION

The present invention relates to a method and a device for measuring a visual range using image sensor systems made up of at least two image sensors.

### BACKGROUND INFORMATION

In a conventional method, a transmitter emits radiation and the scattered-back portions are detected by a receiver and used to calculate the visual range. No information regarding the illumination conditions of the scene and the contrasts of the objects are recorded by this method. These parameters play an important role in the visual-range perception of humans. As a result, this method is not very suitable for applications that require information regarding the visual range perceived by a person.

As described in International Application No. WO 02/06851, the visual range may be determined via a method that utilizes an image sensor, by detecting an object, ascertaining the distance of the object with respect to the image sensor at two different positions of the object, and determining the individual contrast. The method is limited in that the objects must not be moving, and the image sensor itself must be in motion. Furthermore, the method is unsuitable for image sensors that are oriented in the driving direction, for instance in motor vehicles, since small objects must be detected from a great distance and be tracked up to their approach of the motor vehicle. In this connection, there is the problem that an object must be selected from a multitude of objects having low contrast, without it being known whether this is a suitable object and one that is large and rich in contrasts once it comes closer.

Another method for determining the visual range is described in European Patent No. EP 687594 A1. In this method, the presence of fog is determined via the ratio of white and black pixels. This method fails in scenes with poor contrast since it erroneously detects fog here.

### SUMMARY

The method according to an example embodiment of the present invention broadens the functional scope of image sensor systems for ascertaining the visual range that are made up of at least two image sensors. This is particularly advantageous in motor vehicle where image sensor systems, in particular those having two image sensors, are utilized in driver-assistance systems to support the driver. There is no longer any need to install an additional device in the motor vehicle for determining the visual range.

Particularly advantageous is not only the use of the visual range measurement with the aid of image sensor systems in motor vehicles, but also the use in all image sensor configurations in which at least two image sensors record the same scene and already carry out other functions. The application in connection with the monitoring of traffic areas with the aid of image sensor systems is particularly advantageous. By ascertaining the visual range, it is possible here to automatically adapt the display of the allowed maximum speed to the visibility conditions.

In an advantageous manner, the method permits the measuring of the visual range in the case of moving and non-moving image sensor systems. In motor vehicles, it is possible in this way to determine the visibility range in all states of motion, in particular also in a stationary vehicle.

The visual range may advantageously be determined for static and moving objects. When using the present invention in motor vehicles, it is thus possible to determine the visual range in any state of motion of the objects in the surrounding field of the motor vehicle.

In an especially advantageous manner, the method for determining the visual range as described here may consider the illumination of the scene. The method may be used in all application cases where a variable of the visual range is required that corresponds to human perception.

According to a first embodiment of the method, the visual range is calculated in an advantageous manner via arithmetic mean-value generation of at least one individual visual range, which is calculated from the average contrasts of two different distance ranges. This method is advantageously suitable to calculate the visual range at low computing power of the utilized evaluation unit.

Calculating the visual range by forming an exponential regression of the average contrasts over the distance has proven advantageous.

A preprocessing of the image sensor signals may be advantageous. In situations in which only objects of similar size are located in the visual range of the image sensors, for instance, the attenuation of the small-scale contrasts of far-away objects may lead to an underestimation of the visual range due to the optical characteristics of the image sensors. This may be prevented by preprocessing the image sensor signals, in particular by means of high-pass filtering.

In an advantageous manner, the preprocessing of the image sensor signals may improve the image quality, for instance by removing image interferences.

The visual range calculated from the image sensor signals may advantageously be utilized in downstream systems. For example, in driver-assistance systems in motor vehicles, an optical, acoustical and/or haptic warning of the driver is possible once a maximum speed derived from the visual conditions has been exceeded.

In particular the turning on of fog lights and/or the low beam is possible in motor vehicles in the event that a minimum visual range is not attained.

Further advantages will become apparent from the following description of exemplary embodiments with reference to the figures.

### BRIEF DESCRIPTION OF THE DRAWINGS

In the following, the present invention is explained in greater detail in light of the specific example embodiment shown in the figures.

FIG. 1 shows block diagram of the device for measuring the visual range.

FIG. 2 shows a flow chart of the method for determining the visual range 28 from image sensor signals 21 and 22.

FIG. 3 shows the average contrast \overline{C} (x) of objects as a function of distance x, a regression curve 31 and the width of a distance range Δx.

### DESCRIPTION OF EXEMPLARY EMBODIMENTS

FIG. 1 shows a block diagram of the device made up of an image sensor system having an image sensor 11 and a second image sensor 12, two image-sensor signal lines 13 and 14, an evaluation unit 15, an output-signal line 16 and a downstream system 17.

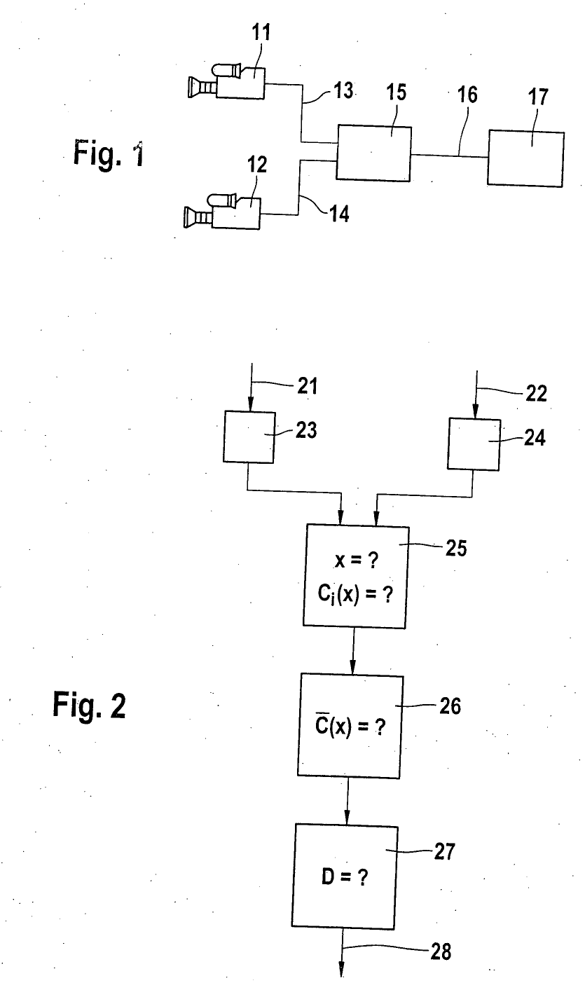

CCD or CMOS cameras, for instance, are able to be utilized as image sensors. Both image sensors are arranged such that they image the same scene, but from a slightly different viewing angle. The image sensors transmit images of the monitored scene to evaluation unit 15. Evaluation unit 15 generates a signal of the measured value of the visual range on output-signal line 16. This output signal is transmitted electronically, digitally, acoustically and/or visually to at least one downstream system 17 for display, information and/or storing. Evaluation unit 15 is made up of a plurality of modules 23, 24, 25, 26 and 27 shown in FIG. 2, which are configured as programs of at least one microprocessor in the preferred exemplary embodiment.

The method is based on a statistical characteristic of natural scenes according to which the probability of an object type occurring is independent of its distance from the image sensor system. In the method, the characteristic of objects i is used that their object contrast c₁, defined as the contrast measured at distance 0, is statistically independent of the position of the object relative to the image sensor system. On statistical average, one can then observe in each distance range x of the image sensor system across all n objects located in this distance range the same average object contrast \overline{c}:

$$\overline{c} = \frac{1}{n} {\sum }_{i - 1}^{n} {c}_{1} ( x ) = const . \qquad ( 1 )$$

The average object contrast c thus is independent of the distance from the image sensor system on statistical average.

The observable contrast Cᵢ (x) of an individual object i having object contrast cl drops with increasing distance, according to Lambert's law, as a function of visual range D:

$${C}_{i} ( x ) = {c}_{i} {ⅇ}^{- \frac{x}{D}} \qquad ( 2 )$$

For average contrast \overline{C} (x) in a certain distance range x across a plurality of objects located in this distance range and which were ascertained within a time window, it holds:

$$\overline{C} ( x ) = \frac{1}{n} {\sum }_{i - 1}^{n} {C}_{i} ( x ) \qquad ( 3 )$$

On the basis of (1) and (2), for the calculation of average contrast C(x) it holds according to (3):

$$\overline{C} ( x ) = \overline{c} {ⅇ}^{- \frac{x}{D}} \qquad ( 4 )$$

Average contrast \overline{C} (x) thereby follows the same exponential law as the observable contrast C₁ (x) of an individual object i.

If measurements of the average contrast for two distance ranges x₁ and x₂ are available, the visual range results as follows:

$$D = \frac{{x}_{2} - {x}_{1}}{ln \overline{C} ( {x}_{1} ) - ln \overline{C} ( {x}_{3} )} \qquad ( 5 )$$

The longer the duration during which the average contrast is measured for a particular distance range and the more objects are present in the scene, the smaller the measuring error in the visual range determination.

FIG. 2 shows a flow chart for implementing the method in a schematic representation. Image sensor signals 21 and 22 of signal lines 13 and 14 are supplied to preprocessing modules 23 and 24.

A distance and contrast measurement is implemented in module 25. There, in the first step, objects that are completely within the visual range of both image sensors are detected using image processing methods via image segmentation. In the second step, the distance of the object from the image sensor system is ascertained. An especially suitable possibility for distance measuring are block-based stereo methods. Here, the distance of the objects is measured via the correlation of image blocks along the epipolar in both images. The distance of the object from the image sensor system may be calculated from the relative displacement of the image blocks in both images, since the distance is inversely proportional to the displacement of the image blocks.

In step three, the contrast of the objects will then be determined. In the preferred exemplary embodiment, the contrast is calculated by way of the amount integral of a cut-off filter across the image block. Other methods known from image processing are possible for calculating the contrast over an image detail, for example the calculation of the standard deviation and the variance of the gray-scale values within an image block.

The method assigns a distance value to each ascertained contrast value. The value pairs thus obtained are transmitted as object characteristic data to downstream module 26 for further processing.

In module 26, the calculation of the average contrast in each distance range is calculated. To this end, the distance is divided into distance ranges. The distance ranges in the preferred exemplary embodiment are characterized by the same width Δx. In a modified method, it is possible to adapt the width of the distance ranges as a function of various parameters, such as time, distance and/or movement state of the image sensor system. The object characteristic data ascertained in module 25 are assigned to the distance ranges. The classification is implemented on the basis of the distance parameter. Within each distance range the average contrast is calculated by mean value generation according to formula (3). The generation of the average contrast is based on object characteristic data, which were ascertained inside a time window prior to the calculation instant. The time window is to be selected such that the visual range does not change significantly inside the window. The average contrasts of each distance range are transmitted to downstream module 27 for calculation of the visual range. Two calculation variants are possible for calculating the visual range. According to a first variant, the visual range is formed by arithmetical mean value generation of at least one individual visual range. The individual visual ranges, such as D(x₃, X₄), are formed from average contrast values of in each case two different distances, here, X_{3 and X}₄, according to formula (5).

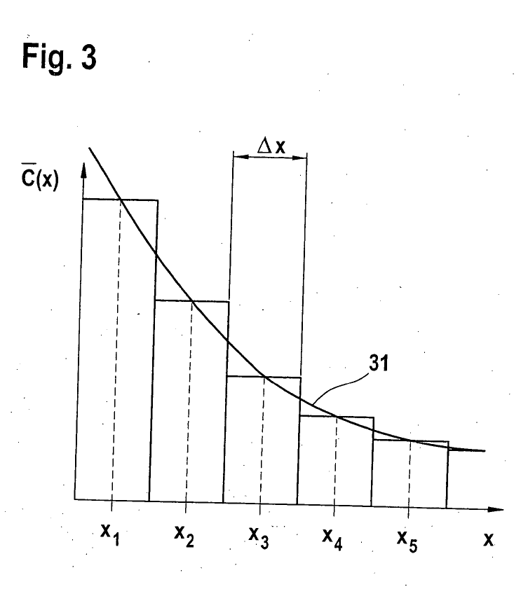

According to a second variant, the visual range may be calculated via an exponential regression, drawn in as regression curve 31 in FIG. 3.

Output signal 28, which is a measure of the visual range, is transmitted via signal line 16 in FIG. 1 to downstream system 17.

FIG. 3 shows the average contrast \overline{C} (x) of objects in the same distance range as a function of distance x. The width of a distance range Δx has been drawn in.

In situations in which only objects of similar size are located within the visual range of the image sensors, the attenuation of the small-scale contrasts of far-away objects could lead to an underestimation of the visual range due to the optical properties of the image sensors. This is able to be prevented by a preprocessing of the image sensor signals in preprocessing modules 23 and 24, in particular by high-pass filtering. As an alternative, it is possible to reduce this error by a corresponding adaptation of the exponential regression curve. In addition, preprocessing modules 23 and 24 may be used to improve the image quality, for instance to remove interference, to improve contrast and/or to sharpen the edge.

The ascertained visual range is transmitted in a suitable manner to at least one downstream system 17. For instance, an adaptation of at least one system on the basis of the visual range is conceivable and/or the deenergizing or energizing of at least one system when leaving an adjustable value range of the visual range. An application possibility results in driver-assistance systems in motor vehicles. Here, an optical, acoustical and/or haptic warning of the driver is conceivable when a maximum speed derived from the visual conditions is exceeded. The method is particularly suited for turning on the fog lights and/or the low beam in motor vehicles when a minimum visual range is not attained. The method may preferably be used to deactivate a distance warning system in motor vehicles based on an image sensor system when a minimum range of vision is not attained.

The method and the device described are not limited to the use of image-processing sensor systems made up of two image-processing sensors in a motor vehicle. With systems having more than two cameras, the visual range may in each case be generated from two image sensor signals. By using statistical methods, the measuring error for the calculated visual range may be reduced. A prerequisite is merely that the image-processing sensors utilized record the same scene.

Furthermore, the described procedure with the corresponding features may be utilized outside of motor vehicle technology. The use in image sensor systems for monitoring traffic spaces comes to mind as application example. For instance, the method may be used for the automatic adaptation of the display of the permitted top speed to the visual conditions and/or for generating a fog warning system for traffic participants.

1-17. (canceled)

18. A method for measuring a visual range using an image sensor system including at least two image sensors, the method comprising:
recording, via the at least two image sensors, a same scene;
ascertaining from image sensors signals from the at least two sensors a first variable which represents a contrast of an image or image detail of the recorded scene;
ascertaining a second variable as a function of the image sensor signals from the at least two image sensors, the second variable representing a distance with respect to a recorded object in the image or the image detail of the recorded scene; and
determining the visual range as a function of the first and second variables.

19. The method as recited in claim 18, wherein the image sensor system includes two image sensors.

20. The method as recited in claim 18, further comprising:
detecting objects in an image area of the at least two image sensors;
determining a distance of each of the detected objects with respect to the image sensor system;
ascertaining a contrast of each of the detected objects;
processing object characteristic data, the object characteristic data including the determined distance and the ascertained contrasts; and
calculating the visual range based on the object characteristic data.

21. The method as recited in claim 20, wherein the processing of the object characteristic data includes:
assigning the distance and the contrast of each of the objects to a value pair;
classifying the value pairs of the objects based on the distance, and subdividing into distance ranges; and
calculating an average contrast in each of the distance ranges.

22. The method as recited in claim 21, wherein the width of each of the distance ranges is the same.

23. The method as recited in claim 21, wherein the width of at least one of the distance ranges is adapted as a function of at least one of time, distance, and state of motion of the image sensor system.

24. The method as recited in claim 20, wherein the distance is calculated from a relative displacement of two corresponding blocks of an object in spatially corresponding images of the two image sensors.

25. The method as recited in claim 18, wherein the contrast of the object in the image or the image detail is formed by an amount integral of a cut-off filter over a selected detail of the image of at least one image of the two image sensors.

26. The method as recited in claim 21, wherein at least one individual visual range is calculated from average contrast values of in each case two different distance ranges with respect to at least one distance range.

27. The method as recited in claim 26, wherein the visual range is formed by subsequent arithmetical mean value generation from at least one individual visual range.

28. The method as recited in claim 21, wherein the visual range is calculated by an exponential regression of the average contrasts over the distance.

29. The method as recited in claim 18, wherein the image sensor signals are preprocessed.

30. The method as recited in claim 18, wherein the determined visual range is used for at least one of: i) adapting at least one downstream system, and ii) energizing or de-energizing at least one system.

31. The method as recited in claim 30, wherein the at least one system is energized or de-energized when an adjustable value range of the visual range is left.

32. The method as recited in claim 18, wherein the image sensor system is located in a motor vehicle.

33. A device for measuring a visual range, comprising:
an image sensor system including at least two image sensors that record a same scene; and
an evaluation unit configured to calculate the visual range from the at least two image sensor signals and to generate an output signal as a measured value which is a measure for the visual range.

34. The device as recited in claim 33, wherein the evaluation unit is configured to perform the following steps:
detecting objects in an image area of the at least two image sensors;
determining a distance of each of the detected objects with respect to the image sensor system;
ascertaining a contrast of each of the detected objects;
processing object characteristic data, the object characteristic data including the determined distance and the ascertained contrasts; and
calculating the visual range based on the object characteristic data.

35. The device as recited in claim 15, wherein the image sensor system is at least one of: made up of two image sensors, and located inside the motor vehicle.
